(19) United States
(12) Patent Application Publication
(10) Pub. No.: US 2022/0104530 A1
(43) Pub. Date: Apr. 7, 2022

(54) COMMERCIAL SCALE 3D FOOD PRINTING

(71) Applicant: FRITO-LAY NORTH AMERICA, INC., Plano, TX (US)

(72) Inventor: Stephen GRAHAM, Plano, TX (US)

(21) Appl. No.: 17/494,177

(22) Filed: Oct. 5, 2021

Related U.S. Application Data
(60) Provisional application No. 63/087,374, filed on Oct. 5, 2020.

(51) Int. Cl. A23P 30/20; A23P 20/20

(52) U.S. Cl. CPC A23P 30/20; B33Y 10/00; A23P 20/20

(57) ABSTRACT

Devices, systems, and methods for 3-dimensional food product printing can include an extruder providing extruded food product to a print platform. The print platform can move in one or more dimensions to assist coordinated 3-dimensional food product printing. A control system can provide coordinated operation between the extruder and the print platform.

### CROSS-REFERENCE TO RELATED APPLICATION

This patent application claims the benefit of and priority to U.S. Provisional Patent Application No. 63/087,374, filed Oct. 5, 2020, the entire disclosure of which is incorporated herein by reference.

### FIELD

The present disclosure relates to devices, systems, and methods for food production, and more particularly to devices, systems, and methods for additive deposition food production.

### SUMMARY

According to an aspect of the present disclosure, a three dimensional food product printing system may include an extruder for food product extrusion, a printed food product transport system adapted to provide a print platform for receiving 3-dimensional additive deposition of food product material from the extruder to print 3-dimensional food products, the printed food product transport system including an actuator system adapted to move the print platform in at least one dimension for shaping additive deposition of food product material to form the printed three dimensional food products, and a control system for operating the printed food product transport system. The control system may be configured to determine movement of the print platform for shaping additive deposition of food product material from the extruder to form the printed 3-dimensional food products, and to communicate commands to the printed food product transport system based on the determined movement.

In some embodiments, the actuator system may be adapted to move the print platform in at least two dimensions. The actuator system may be adapted to move the print platform in at least three dimensions, and a print head of the extruder may remain stationary. In some embodiments, the extruder may include a print head for additive deposition of food product material onto the print platform. The print head may include an adaptor for transferring food product material expelled laterally by the extruder to vertically-oriented food product material for vertical additive deposition by the print head. In some embodiments, a print head of the extruder may be adapted for additive deposition of food product material onto the print platform at a pressure within the range of about 750 psi to about 2000 psi at the print head.

In some embodiments, the printed product transport system may include a conveyor supporting the print platform. The conveyor may define a linear operation direction along which the conveyor translates. The linear operation direction of the conveyor may comprise a dimension of movement providing one of the at least one dimensions of movement of the print platform.

In some embodiments, the actuator system may include a rack and pinion operator for moving the print platform. The rack and pinion operator may move the print platform along one of the width and/or height dimensions, orthogonal to a linear operation direction of the printed product transport system.

In some embodiments, the screw extruder may comprise a print head including a plurality of pressure nozzles. Each nozzle may be adapted for shaping additive deposition of food product material onto the print platform. Each nozzle may be adapted for simultaneous additive deposition of food product material onto the print platform. In some embodiments, the actuator system may be adapted to move the print platform in a height dimension and a lateral dimension.

According to another aspect of the present disclosure, a three dimensional food product printing apparatus may include an extruder system having at least one screw, a print head having a plurality of nozzles for 3-dimensional additive deposition of food product material onto a print platform, and an adapter configured to transfer food product material from the at least one screw to the print head, and a control system for operating the extruder system in coordination with a printed food product conveyor system to form printed 3-dimensional food products. In some embodiments, the print head may be adapted to move in no more than two dimensions.

In some embodiments, the control system may be adapted to move the print head in coordination with the print platform such that the print head moves in no more than two dimensions and the print platform moves in at least one dimension. The control system may be adapted to move the print head and the print platform in a combined total of three dimensions. The control system may be configured to coordinate movement of the print head in coordination with movement of a rack and pinion operator of the print platform.

In some embodiments, the control system may be configured to operate the extruder with the print head stationary and the print platform moving in three dimensions to provide 3-dimensional printed food product. The at least one screw may be arranged horizontally and the print head may be arranged vertically. The adapter may be configured to transfer horizontally extruded food product material from at least one screw to the vertically arranged print head. In some embodiments, the print head may be adapted for additive deposition of food product material onto the print platform at a pressure within the range of about 750 psi to about 2000 psi at the print head.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The concepts described in the present disclosure are illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

The detailed description particularly refers to the accompanying figures in which:

FIG. 1 is an elevation view of a 3-dimensional food product printing system;

FIG. 2 is a diagrammatic view of portions of the 3-dimensional (3D) food product printing system of FIG. 1 showing that an extruder provides food product material to a print head for additive deposition on a movable print platform, and showing that an adaptor transfers food product material from the extruder to the print head for 3D printing;

FIG. 3 is a partially perspective view of the 3-dimensional food product printing system of FIGS. 1 and 2 showing that the print head includes a plurality of nozzles for food product material deposition onto the print platform;

FIG. 4 is a diagrammatic plan view of the print platform of the 3-dimensional food product printing system of FIGS. 1-3;

FIG. 5 is a diagrammatic view of a control system of the 3-dimensional food product printing system of FIGS. 1-4;

FIG. 6 is a partially perspective view of another embodiment of a 3-dimensional food product printing system similar to that of FIGS. 1-5, but showing a moveable print head;

FIG. 7 is table indicating a variety of configurations for the 3-dimensional food product printing systems of FIGS. 1-6; and

FIG. 8 is a partially perspective view of another embodiment of a 3-dimensional food product printing system similar to that of FIGS. 1-6, but showing a vertically oriented extruder.

### DETAILED DESCRIPTION

While the concepts of the present disclosure are susceptible to various modifications and alternative forms, specific embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

Conventionally-extruded food products can create interesting food product forms at high production rates, suitable for commercial production. Food extrusion can generally include a drive, such as an extruder, which forces food product material through a die insert. The die insert includes openings having a particular shape to form a desired food product as the food material passes through the die insert. Extruders can employ face cutting in which a blade cuts or dissects one extrusion of food product from another, although remote cutting may be applied in some instances. However, extruded food production can face challenges and/or limitations.

For example, the complexity and/or attributes of the shapes available for conventionally-extruded food products can be limited in commercially viable applications producing high rates of food product output, for example, output rates above about 220 lb/hr (about 100 kg/hr), above about 750 lb/hr (about 340 kg/hr), or above about 2000 lb/hr (about 900 kg/hr), for example, from about 220 to about 1100 lb/hr (about 100 to about 500 kg/hr), or about 1100 to about 3300 lb/hr (about 500 to about 1500 kg/hr). Moreover, conventionally extruded food products can be limited according to the particular die insert, and may require different dies in order to provide different shapes and/or food textures. Additionally, face-cutting in food extrusion can lack precision control of the food product shapes, and particularly, precision control of the food product shape in all three dimensions. Lack of precision shape control can limit the ability to independently control one or more of appearance, texture, resilience, and bulk density of food products.

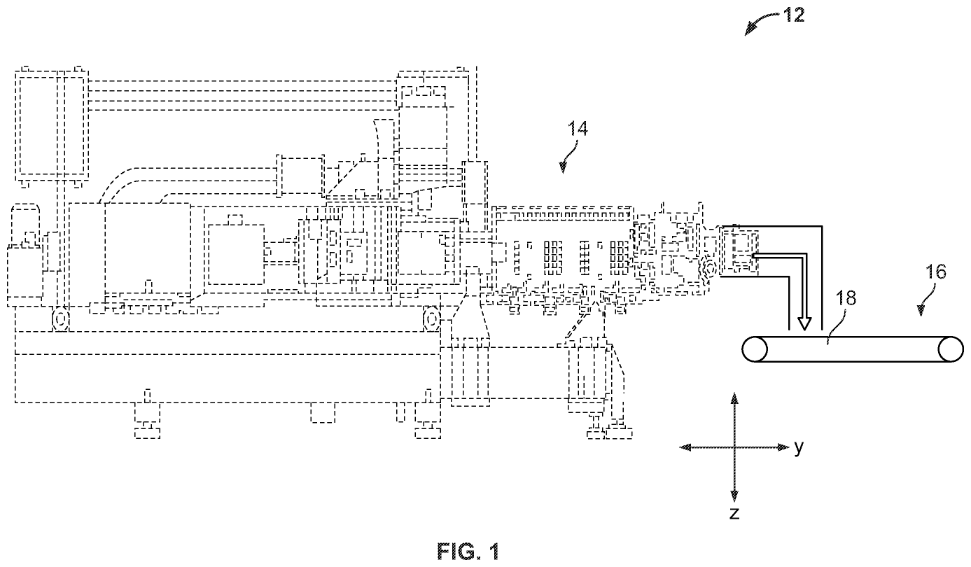

Referring now to the illustrative embodiment of FIG. 1, a 3-dimensional (3D) food product printing system 12 is shown for providing additive manufacturing of food product. The 3-dimensional food product printing system 12 includes an extruder 14 for extruding food product to support the additive manufacturing food product process. The 3-dimensional food product printing system 12 includes a printed food product transport system 16 for providing a print platform 18 to receive additive deposition of food product from the extruder 14 to print 3-dimensional food product.

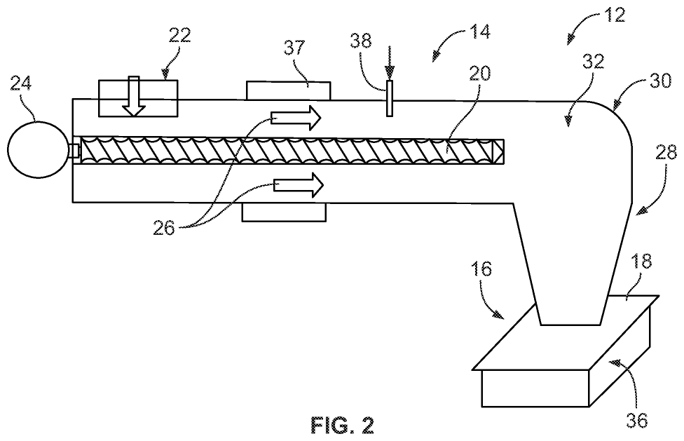

Referring to FIG. 2, a diagrammatic view of portions of the 3-dimensional food product printing system 12 is shown. In the illustrative embodiment, the extruder 14 is embodied as a screw extruder having a single screw 20 which provides extrusion driving force; although in some embodiments, any suitable manner of extruder may be applied, for example, dual screw extruders, and/or piston extruders. Food material is loaded into the extruder 14 at a hopper 22 for engagement with the screw 20. The screw 20 is rotated along its longitudinal dimension by a drive motor 24 to drive food material through the body of the extruder 14, as suggested by arrows 26, towards a print head 28. Food product material is output from the extruder laterally and transitioned vertically for deposition onto a print platform 18.

The print head 28 receives food product from the screw 20 for depositing onto the printing platform 18. An adaptor 30 is connected between the screw 20 and the print head 28 for transitioning the food product material therebetween. In the illustrative embodiment, the extruder 14 is a horizontal screw extruder, in which the screw 20 is arranged along the horizontal direction to drive food product laterally.

The adaptor 30 provides a food flow transition to transfer the laterally driven food from the screw 20 into vertically deposited food product through the print head 28. The adaptor 30 illustratively includes a geometrically defined interior flow passage 32 for smoothly transitioning the food product material to the print head 28 at formation pressures, for example, within a range of about 750 psi to about 2000 psi. The flow passage 32 connects with the print head 28 to provide pressurized food product material to the print platform 18.

In the illustrative embodiment, the print platform 18 is adapted for movement by an actuator system 36. The actuator system 36 illustratively moves the print platform 18 in conjunction with food product material deposited by the print head 28 to form 3-dimensional food products. By way of non-limiting example, 3-dimensional food product printing includes deposition of food product material layer-by-layer onto the print platform 18 to build a stack of finely controlled deposit layers which enables interesting and/or complex shape, texture, and/or form characteristics in the food product. As discussed in additional detail below, movement of the print platform 18 of the 3-dimensional food product transfer system 16 can include formation of multiple 3-dimensional food products simultaneously.

The extruder 14 illustratively includes peripherals for assisting and/or monitoring extrusion. For example, the extruder 14 may include heater/coolers 37 and/or ports 38. The heater/cooler 37 may be formed to provide temperature control during extrusion, and ports 38 may provide access for injection of ingredients, such as water, and/or for probes such as temperature probes for monitoring extrusion activities.

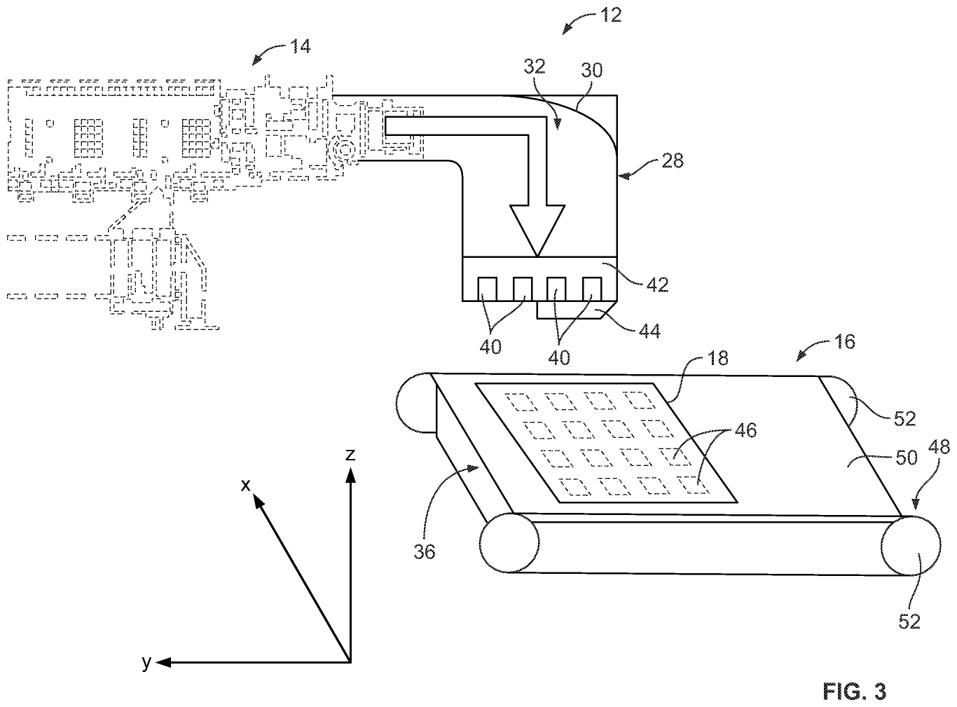

Referring now to FIG. 3, the print head 28 is shown including a plurality of print nozzles 40. In the illustrative embodiment, the print head 28 includes a receiver 42 defining a number of receptacles for receiving the print nozzles 40. The receptacles, and thus the print nozzles 40, are arranged spaced apart from each other in communication with the extruder 14 via the adaptor 30 to receive pressurized food material for deposition on the print platform 18. The print head 28 may include a face blade 44 for cutting the food product across the face of the nozzles 40 to assist food product formation and/or transition.

Still referring to FIG. 3, the arrangement of the print nozzles 40 is suggested by observation of the print platform 18 illustrated in three dimensions (lateral x, longitudinal y, vertical z). In the illustrative embodiment, the print head 28 includes sixteen (16) print nozzles 40 spaced apart from each other and operating in parallel, as suggested by the sixteen (16) distinct print areas 46. Each print area 46 represents a print area available for receiving deposition of food product from an individual one of the print nozzles 40. Parallel operation of the nozzles 40 can yield multiple printed food products produced simultaneously having similar shape, and the use of the same style of nozzle 40 for all print areas 46 can yield multiple food products having similar characteristics, such as texture. In some embodiments, different portions of shapes may be created with individualized control of nozzles 40, and/or the style of each nozzle 40 may be varied according to their location (by print area).

Referring to the illustrative embodiment of FIG. 3, the actuator system 36 moves the print platform 18 in coordinated operation with the deposition of food product material for 3-dimensional printing of food products. The actuator system 36 is illustratively embodied as a moveable transport, such as a conveyor, presenting the print platform 18 as a receiving area for the food product material deposited by the print head 28. The actuator system 36 is adapted to move the print platform 18 in three dimensions to enable coordinated deposition of food product material in additive manufacturing of the printed food product.

The actuator system 36 is illustratively embodied to provide movement in the lateral (x) direction to allow deposition of food product material along the lateral (x) direction of the print areas 46. The actuator system 36 includes a lateral actuator embodied as a rack and pinion actuator, although in some embodiments, any suitable actuator may be applied for example, belt, screw, rotary, pneumatic, and/or, linear motor actuators. The actuator system 36 is illustratively embodied to provide movement in the vertical (z) direction to allow deposition of food product material along the vertical (z) direction of the print areas 46, for example, to deposit different layers of food product material. The actuator system 36 includes a vertical actuator embodied as a rack and pinion actuator, although in some embodiments, any suitable actuator may be applied for example, belt, screw, rotary, pneumatic, and/or, linear motor actuators. In some embodiments, a dual-action actuator may be applied to provide motion of the print platform 18 in the lateral and vertical directions.

The actuator system 36 is illustratively embodied to provide movement in the longitudinal (y) direction to allow deposition of food product material along the longitudinal (y) direction of the print areas 46. The actuator system 36 includes a longitudinal actuator embodied as a belt actuator comprising a conveyor belt 48 operating for forward and/or reverse drive. In the illustrative embodiment, the longitudinal actuator comprises a section 50 of a belt (endless) conveyor providing the print platform 18. The section 50 of the belt conveyor is illustratively driven by rollers 52, which are supported by the lateral and vertical actuators such that the section 50 of the belt conveyor is itself shifted laterally and vertically according to the lateral and vertical actuator operation. In some embodiments, the longitudinal actuator may include any suitable actuator for example, rack and pinion, screw, rotary, pneumatic, and/or, linear motor actuators.

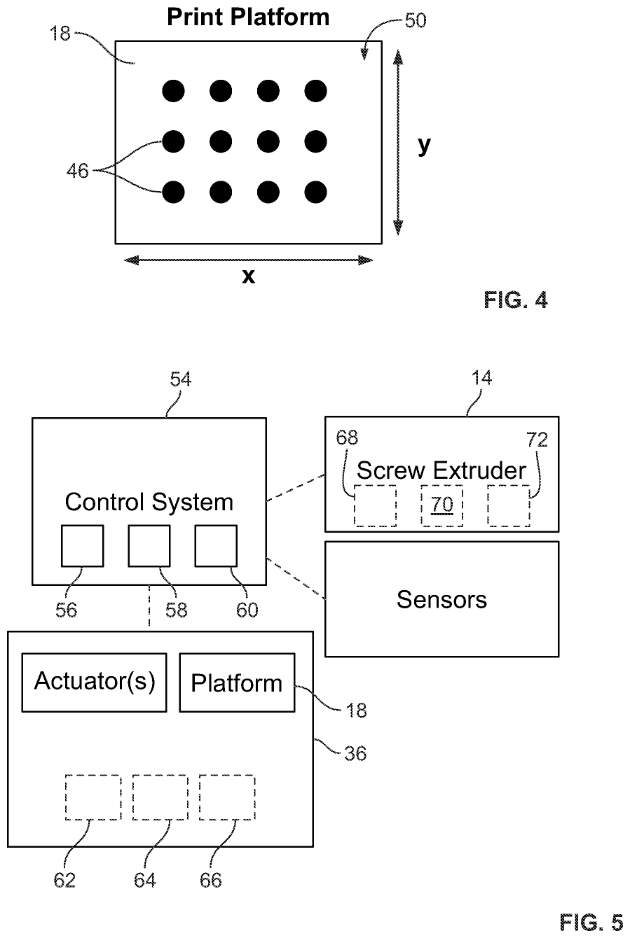

Referring to the overhead view of the print platform 18 in FIG. 4, in the illustrative embodiment, section 50 of the belt conveyor is driven along the y-direction to move the print platform 18 as needed for positioning to receive deposition of food product material along the y-direction for each print area 46, while the lateral actuator is operable to move the section 50 of the belt conveyor, and thus the print platform 18, as needed for positioning to receive deposition of food product material along the x-direction, and while the vertical actuator is operable to move the section 50 of the belt conveyor, and thus the print platform 18, as needed for positioning to receive deposition of food product material along the z-direction (into the page in the orientation of FIG. 4). By way of non-limiting example, the deposition of food product material can be controlled along the x-y plane to create an intricate and/or form-controlled layer of food product on the print platform 18. Thereafter, the print platform 18 can be moved to adjust the position in the z direction, to allow another deposition layer to be placed in the x-y. Repeated layering builds the 3D stack of layers to form the 3D printed food product.

Referring now to FIG. 5, the 3-dimensional food product printing system 12 includes a control system 54 for governing operation. The control system 54 includes a processor 56, memory 58, and communication circuitry 60. The processor 56 executes instructions stored on memory 58 and communicates signals via communication circuitry 60 to govern operation of the 3-dimensional food product printing system 12. The control system 54 communicates with the extruder 14 and actuator system 36, and various sensors, for coordinated operation for 3D food product printing.

The control system 54 communicates with the actuator system 36 to govern movement of the print platform 18. In the illustrative embodiment, the control system 54 issues command signals to the lateral, vertical, and/or longitudinal actuators, as appropriate, to position the print platform 18 for receiving deposition of food product material from the print head 28. In some embodiments, the actuator system 36 may include a processor 62, memory 64, and/or communication circuitry 66 for receiving governing commands from the control system 54 and determining and executing operations of the actuator system 36.

The control system 54 communicates with the extruder 14 to govern extruder operation, for example, operation of the screw 20 and/or print head 28. In the illustrative embodiment, the control system 54 issues command signals to the extruder 14, as appropriate, in coordination with the positioning of the print platform 18 for depositing food product material onto the print platform 18. In some embodiments, the extruder 14 may include a processor 68, memory 70, and/or communication circuitry 72 for receiving governing commands from the control system 54 and determining and executing operations of the extruder 14.

Accordingly, the control system 54 can operate the extruder 14 and actuator system 36 in coordination with each other to provide additive deposition of food material from the nozzles 40 to the respective print areas 46. The control system 54 governs sequencing of additive deposition such that a plurality of 3D printed food products can be simultaneously built. In the illustrative embodiment, once the build process is complete, the longitudinal actuator as a section 50 of a conveyor belt can be operated to transport the print platform 18 for unloading and to present another print platform 18 for further build processes, in rapid succession to support commercial production rates.

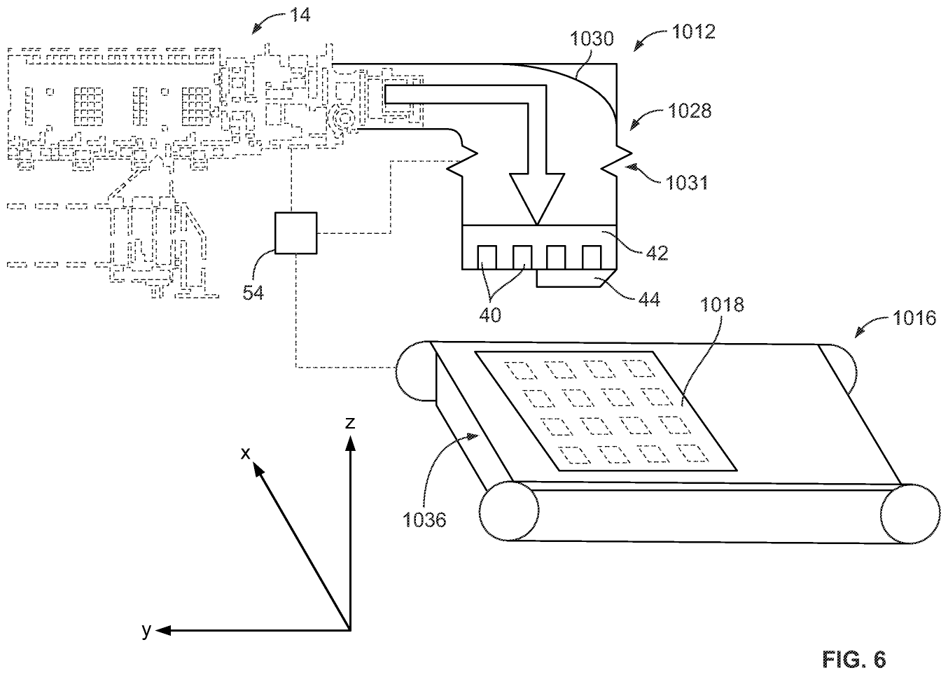

Referring now to FIG. 6, another embodiment of a 3-dimensional food product printing system 1012 is shown having a movable print head 1028. The 3-dimensional food product printing system 1012 is similar to the printing system 12, and the disclosure regarding printing system 12 applies equally to the 3-dimensional food product printing system 1012 unless otherwise indicated. Unlike the 3-dimensional food product printing system 12, the print head 1028 is moveable in at least one dimension, in coordination with the print platform 1018, for 3-dimensional printing of food product.

The 3-dimensional food product printing system 1012 includes the extruder 14, print head 1028, and printed food product transport system 1016. The print head 1028 includes an actuation assembly 1031 for positioning the nozzles 40. The actuation assembly 1031 illustratively includes motion actuators and food product material distribution for depositing the food product material from the nozzles 40 onto the print platform 18 under movement of the print head 1028 about its one or more dimensions of operability. Food product material from the extruder 14 is transferred to the print head 1018 via an adaptor 1030 which can be particularly formed for movement of the print head 1018, for example, including articulable sections as required. Operation of the 3-dimensional food product printing system 1012 is governed by control system 54, which provides command signals for relevant movement of the print head 1028, as applicable, in coordination with commands for the extruder 14 and transport system 1016 according to the disclosure herein.

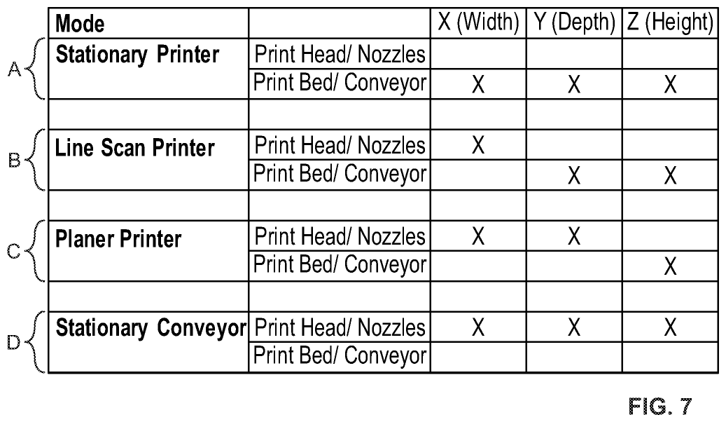

Referring briefly to FIG. 7, a table indicates various modes for coordinated movement for 3D printing between the print head 1028 and the printed product transport system 1016. In row A, the mode is indicated as “stationary printer” indicating the operations of the 3-dimensional food product printing system 12 in which the printer head 28 remains stationary and the transport system 16 provides movement of the print platform 18 relative to the print head 28 in three dimensions, although the 3-dimensional food product printing system 1012 may be optionally operated in similar manner. In rows B, C, and D, the 3-dimensional food product printing system 1012 is indicated in various configurations.

In row B, the mode is indicated as “line scan printer” indicating that the print head 1018 is adapted for movement in the lateral (x) direction while the transport system 1016 provides movement of the print platform 1018 in the vertical (z) and longitudinal (y) directions, in coordination with the print head 1028. In row C, the mode is indicated as “planer printer” indicating that the print head 1028 is adapted for movement in the lateral (x) and longitudinal (y) directions while the transport system 1016 provides movement of the print platform 1018 in the vertical (z) direction, in coordination with the print head 1028. In row D, the mode is indicated as “stationary conveyor” indicating that the print platform 1018 remains stationary during food material deposition while the print head 1018 moves in any of the three dimensions (x, y, z) for 3D food product printing.

The printed food product transport system 1016 includes an actuator system 1036 for movement of the print platform 1018 in at least the one or more dimensions in which the print head 1028 does not move. For example, in embodiments providing the mode B “line scan printer”, the actuator system 1036 is adapted to provide movement of the print platform 1018 in the longitudinal (y) and vertical (z) directions. In some embodiments, the print head 1028 and actuator system 1036 may capable of movement in one or more of the same dimensions, for example, each in the lateral (x), longitudinal (y), and/or vertical (z) directions for 3D printing, and their relative movement in the same dimension may be coordinated according to the particular designs of the 3D printed food product to be printed, for example, to enhance convenience, range, timeliness, and/or control. In some embodiments, the print head 1018 and/or print head 1018 (via the actuator system 1036) may be adapted for movement in any combination of dimensions, but may be operated according to a select mode as indicated in FIG. 7.

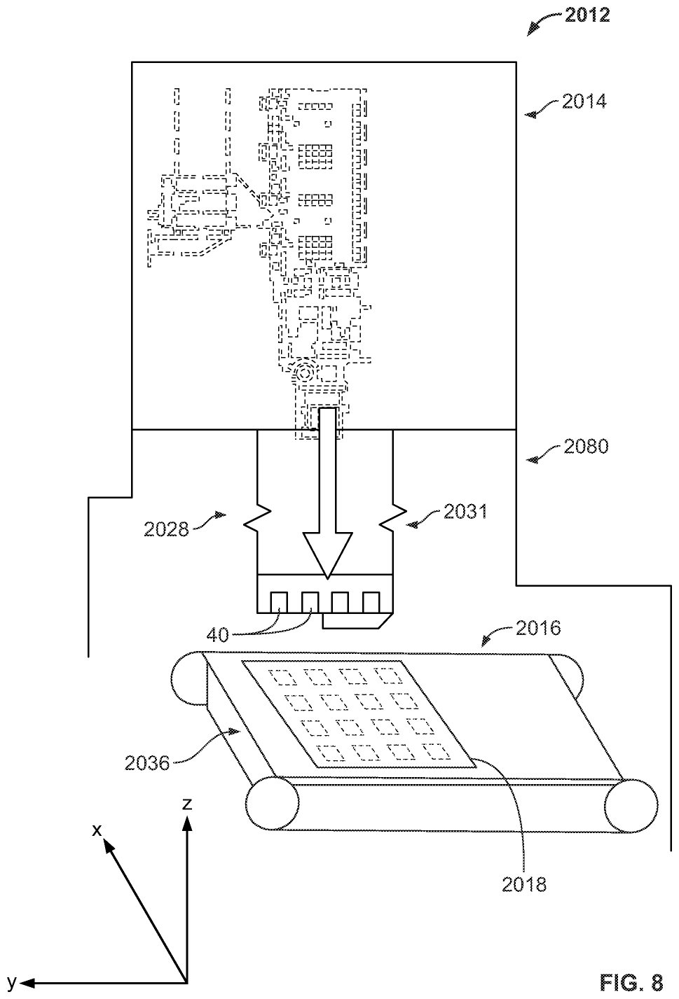

Referring now to FIG. 8, another embodiment of a 3-dimensional food product printing system 2012 is shown. The 3-dimensional food product printing system 2012 is similar to the 3-dimensional food product printing systems 12, 1012 and the disclosure regarding the 3-dimensional food product printing systems 12, 1012 applies equally to the 3-dimensional food product printing system 2012 unless otherwise indicated. Unlike the 3-dimensional food product printing systems 12, 1012, the 3-dimensional food product printing system 12 includes an extruder 2014 arranged to expel food product vertically without an adaptor, such as adaptors 30, 1030. In the illustrative embodiment, the extruder 2014 is a screw extruder having its driving screw oriented such that its longitudinal length extends vertically, rather than horizontally. Accordingly, the extruder 2014 includes support structure 2080 to support the industrial sized extruder above the print platform 2018 for 3D food product printing.

The print head 2028 may optionally include actuation system 2031 for coordinated movement together with the actuator system 2036. However, the actuation system 2031 may be omitted in some embodiments, and movement in all three dimensions for 3D printing may be provided by the actuator system 2036 via the print platform 2018. Control of 3D food product printing operations for 3-dimensional food product printing system 2012 is illustratively governed by control system 54. Vertical orientation of the food material outputted from the extruder 2014 to the print head 2028 can align the flow of the food product material for deposition, and may reduce flow complexity.

Within the present disclosure, devices, systems, and methods for 3-dimensional food product printing can provide commercial scale food product. Advantages of complex food product shapes, textures, and/or forms can be provided at commercial production rates. Such productivity can be accomplish with conventional extrusion machinery, while harnessing the advantages of additive deposition in a manner to reach commercially viable quality and/or production rates. Food product design changes can be rapidly implemented by altering the 3D print deposition. Moreover, commercial production rates can be achieved with desirable product shapes, textures, and/or forms requiring particular product deposition pressure control, temperature, exit velocity, and/or formulation control. Devices, systems, and methods within the present disclosure can enable food product at commercially viable rates including complex shapes, abstract geometries, and/or functional forms (e.g., scoop, bowl).

In a Low Conditions mode, the 3-dimensional food product printing systems of the present disclosure may operate at a low pressure and/or temperature, for example, with conditions low enough to mix and form extrudate food product material into desired shape but without cooking the food product material (e.g., Rold Gold Pretzel Twists® as marketed by Frito-Lay North America, of Plano, Tex.). Such Low Conditions mode can include an extrusion pressure within the range of about 30 to about 200 psig (about 2.1 to about 14 bar), and/or an extrusion temperature within the range of about 80 to about 160° F. (about 27 to about 71° C.).

In a Medium Conditions mode, the 3-dimensional food product printing systems of the present disclosure may operate at a medium pressure and/or temperature, for example, with conditions to mix and form extrudate food product material into desired shape with some cooking of the food product material (starch gelatinization/protein denaturing) but below the boiling point of water to avoid rapid evaporation of water within the food product material to produce an expanded product (E.g., Sun Chips® as marketed by Frito-Lay North America, of Plano, Tex.). Such Medium Conditions mode can include an extrusion pressure within the range of about 800 to about 1400 psig (about 55 to about 96 bar), and/or an extrusion temperature within the range of about 160 to about 240° F. (about 71 to about 115° C.).

In a High Conditions mode, the 3-dimensional food product printing systems of the present disclosure may operate at a high pressure and/or temperature, for example, with conditions to mix and form extrudate food product material into desired shape with cooking of the food product material including raising the to the boiling point of water within the food product material to cause rapid expansion of trapped water within the food product material (E.g., Cheetos® as marketed by Frito-Lay North America, of Plano, Tex.). Such High Conditions mode can include an extrusion pressure within the range of about 1500 to about 2000 psig (about 104 to about 138 bar), and/or an extrusion temperature within the range of about 300 to about 450° F. (about 150 to about 232° C.).

Within the present disclosure various hardware indicated may take various forms. Examples of suitable processors may include one or more microprocessors, integrated circuits, system-on-a-chips (SoC), among others. Examples of suitable memory, may include one or more primary storage and/or non-primary storage (e.g., secondary, tertiary, etc., storage); permanent, semi-permanent, and/or temporary storage; and/or memory storage devices including but not limited to hard drives (e.g., magnetic, solid state), optical discs (e.g., CD-ROM, DVD-ROM), RAM (e.g., DRAM, SRAM, DRDRAM), ROM (e.g., PROM, EPROM, EEPROM, Flash EEPROM), volatile, and/or non-volatile memory; among others. Communication circuitry includes components for facilitating processor operations, for example, suitable components may include transmitters, receivers, modulators, demodulator, filters, modems, analog to digital converters, operational amplifiers, and/or integrated circuits.

While certain illustrative embodiments have been described in detail in the figures and the foregoing description, such an illustration and description is to be considered as exemplary and not restrictive in character, it being understood that only illustrative embodiments have been shown and described and that all changes and modifications that come within the spirit of the disclosure are desired to be protected. There are a plurality of advantages of the present disclosure arising from the various features of the methods, systems, and articles described herein. It will be noted that alternative embodiments of the methods, systems, and articles of the present disclosure may not include all of the features described yet still benefit from at least some of the advantages of such features. Those of ordinary skill in the art may readily devise their own implementations of the methods, systems, and articles that incorporate one or more of the features of the present disclosure.

We claim:

1. A three dimensional food product printing system, comprising:
an extruder for food product extrusion,
a printed food product transport system adapted to provide a print platform for receiving 3-dimensional additive deposition of food product material from the extruder to print 3-dimensional food products, the printed food product transport system including an actuator system adapted to move the print platform in at least one dimension for shaping additive deposition of food product material to form the printed three dimensional food products, and
a control system for operating the printed food product transport system, the control system configured to determine movement of the print platform for shaping additive deposition of food product material from the extruder to form the printed 3-dimensional food products, and to communicate commands to the printed food product transport system based on the determined movement.

2. The system of claim 1, wherein the actuator system is adapted to move the print platform in at least two dimensions.

3. The system of claim 1, wherein the actuator system is adapted to move the print platform in at least three dimensions, and a print head of the extruder remains stationary.

4. The system of any of claim 1, wherein the extruder includes a print head for additive deposition of food product material onto the print platform, the print head including an adaptor for transferring food product material expelled laterally by the extruder to vertically-oriented food product material for vertical additive deposition by the print head.

5. The system of claim 4, wherein a print head of the extruder is adapted for additive deposition of food product material onto the print platform at a pressure within the range of about 750 psi to about 2000 psi at the print head.

6. The system of claim 1, wherein the printed product transport system includes a conveyor supporting the print platform.

7. The system of claim 6, wherein the conveyor defines a linear operation direction along which the conveyor translates.

8. The system of claim 7, wherein the linear operation direction of the conveyor comprises a dimension of movement providing one of the at least one dimension of movement of the print platform.

9. The system of claim 1, wherein the actuator system includes a rack and pinion operator for moving the print platform.

10. The system of claim 9, wherein the rack and pinion operator moves the print platform along one of the width and/or height dimensions, orthogonal to a linear operation direction of the printed product transport system.

11. The system of claim 1, wherein the screw extruder comprises a print head including a plurality of pressure nozzles, each nozzle adapted for shaping additive deposition of food product material onto the print platform.

12. The system of claim 11, wherein each nozzle is adapted for simultaneous additive deposition of food product material onto the print platform.

13. The system of claim 1, wherein the actuator system is adapted to move the print platform in a height dimension and a lateral dimension.

14. A three dimensional food product printing apparatus comprising:
an extruder system having at least one screw, a print head having a plurality of nozzles for 3-dimensional additive deposition of food product material onto a print platform, and an adapter configured to transfer food product material from the at least one screw to the print head, and
a control system for operating the extruder system in coordination with a printed food product conveyor system to form printed 3-dimensional food products.

15. The three dimensional food product printing apparatus of claim 14, wherein the print head is adapted to move in no more than two dimensions.

16. The three dimensional food product printing apparatus of claim 14, wherein the control system is adapted to move the print head in coordination with the print platform such that the print head moves in no more than two dimensions and the print platform moves in at least one dimension.

17. The three dimensional food product printing apparatus of claim 16, wherein the control system is adapted to move the print head and the print platform in a combined total of three dimensions.

18. The three dimensional food product printing apparatus of claim 14, wherein the control system is configured to coordinate movement of the print head in coordination with movement of a rack and pinion operator of the print platform.

19. The three dimensional food product printing apparatus of claim 14, wherein the control system is configured to operate the extruder with the print head stationary and the print platform moving in three dimensions to provide 3-dimensional printed food product.

20. The three dimensional food product printing apparatus of claim 14, wherein the at least one screw is arranged horizontally and the print head is arranged vertically, and the adapter is configured to transfer horizontally extruded food product material from at least one screw to the vertically arranged print head.

21. The three dimensional food product printing apparatus of claim 14, wherein the print head is adapted for additive deposition of food product material onto the print platform at a pressure within the range of about 750 psi to about 2000 psi at the print head.
